(19) United States
(12) Patent Application Publication
(10) Pub. No.: US 2025/0359544 A1
(43) Pub. Date: Nov. 27, 2025

(54) ORGAN PRESERVATION AND TRANSPORTATION DEVICE

(71) Applicant: Samuel Jacob, Jacksonville, FL (US)

(72) Inventor: Samuel Jacob, Jacksonville, FL (US)

(21) Appl. No.: 18/672,603

(22) Filed: May 23, 2024

(51) Int. Cl. A01N 1/02

(52) U.S. Cl. CPC A01N 1/145

(57) ABSTRACT

A universal preservation and transportation device for human organs is disclosed. The device comprises a lower unit and a removable lid that can be attached to the lower unit. A cooling unit and associated power supply can maintain a consistent temperature within the inner compartment, which can be controlled via a control unit and/or remote control. The device also includes a GPS chip for tracking its location.

### BACKGROUND OF THE INVENTION

The present invention relates to organ preservation and transportation devices.

Conventional organ preservation and transportation devices and methods have several limitations and challenges:

Limited Preservation Time: Organs have a limited window of time during which they can be preserved outside the body. This can create logistical challenges, especially for long-distance transportation or when there are delays in organ procurement and transplantation procedures.

Primary graft disfunction: Current preservation methods involve storing organs at low temperatures to slow down metabolism and reduce cellular damage.

All devices available now depend on ice pads to lower the temperature and give a range. However, uncontrolled temperatures and lack of preservation fluids can cause injury to the organ tissues over time, impacting their function and viability post-transplantation.

Transportation Logistics: Coordinating the transportation of organs from donors to recipients involves intricate logistical challenges, including coordinating flight schedules, ground transportation, and ensuring timely delivery to the transplant center. Delays or mishaps in transportation can lead to organ damage or even loss of transplant opportunities. In addition, you cannot use it for solution transportation to the donor site.

High Cost: Conventional devices and methods of organ preservation and transportation often involve specialized equipment and personnel, which can be costly, and companies make them disposable for each organ to make maximum profit. These expenses add to the overall cost of organ transplantation procedures, making them less accessible to patients, particularly in regions with limited resources.

### SUMMARY OF THE INVENTION

In a preferred embodiment, the present invention is directed toward a device for human organ preservation and transportation that operates under dial up or down exact controlled temperature for longer periods of time and with GPS tracking and mobilize through robotic function and reduce the cost substantially. In addition, this device can be used as a universal organ carrier to transport hearts, lungs, livers, and kidneys, to name a few.

These and other features, aspects and advantages of the present invention will become better understood with reference to the following drawings, description, and claims.

### BRIEF DESCRIPTION OF THE DRAWINGS

FIG. 1 is a schematic view of an organ preservation and transportation device in accordance with a preferred embodiment of the present invention;

FIG. 2 is a cross sectional schematic view of an organ preservation and transportation device in accordance with a preferred embodiment of the present invention; and

FIG. 3 is an exploded schematic view of an organ preservation and transportation device in accordance with a preferred embodiment of the present invention together with various sized organs.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a device for human organ preservation and transportation under controlled temperatures for extended periods of time with GPS tracking. A device constructed in accordance with the present invention will reduce primary graft dysfunction, reduce complications associated with conventional devices, and help reduce mortality.

Conventional devices rely primarily on ice packs to maintain a cool temperature, but ice packs do a poor job of maintaining a consistent temperature over time, which is important to prevent damage to the organ being transported.

In contrast, a device constructed in accordance with the present invention will permit setting a precise temperature that will be maintained for an extended period of time. The device can also be robotic with a fixed part and a disposable part, which will help keep the cost down. In addition, the device has built in GPS tracking for the transplant team.

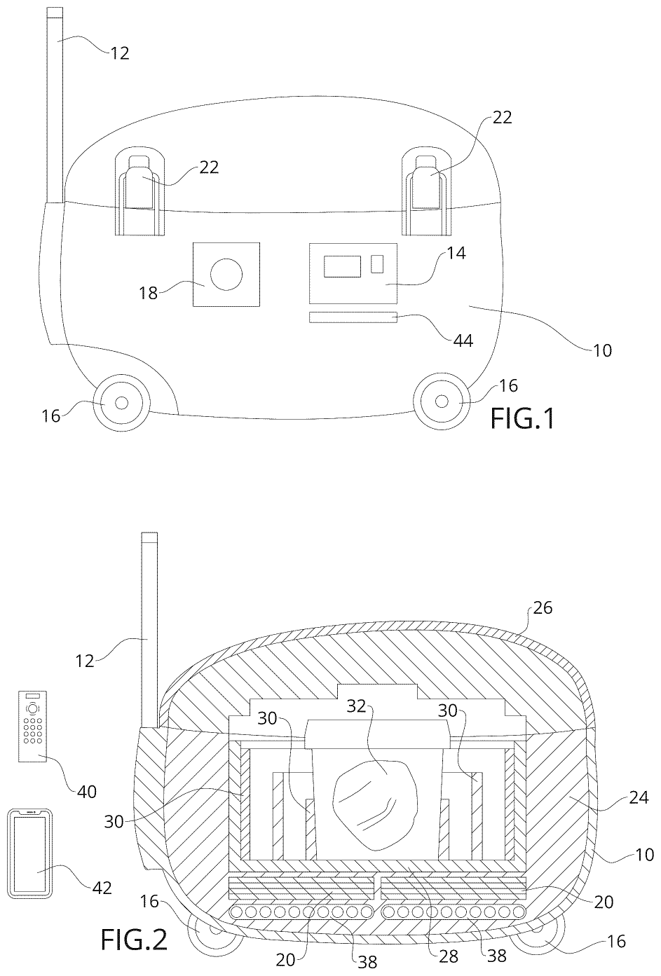

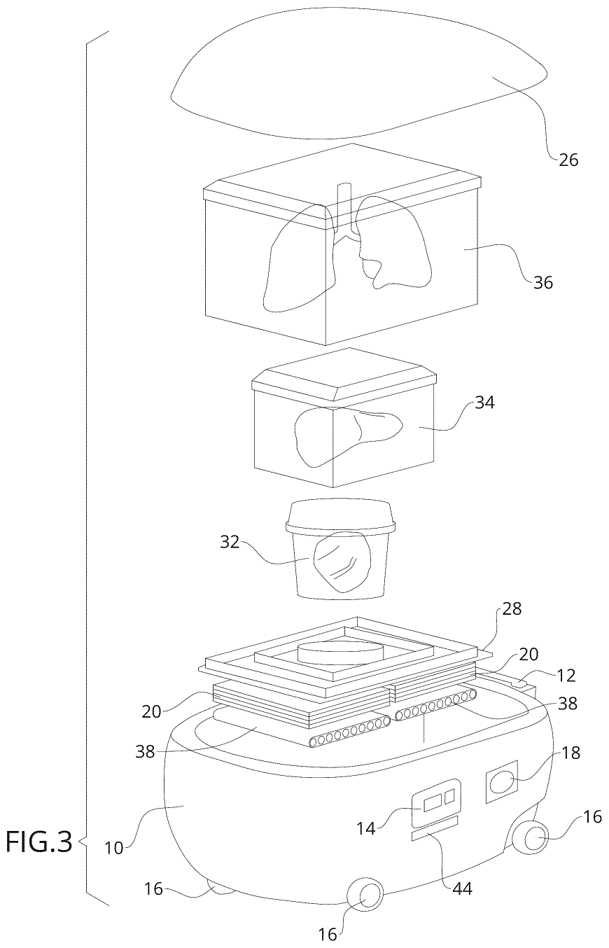

As described herein, and as seen in FIGS. 1-3, the organ preservation and transport device of the present invention comprises a lower case 10 and a lid 26 that fits on top of lower case 10. As seen in FIG. 1, lid 26 is secured to lower case 10 via one or more latches 22. As seen in the Figures, when lid 26 is secured to lower case 10 an inner compartment is formed. Lower case 10 also has a handle 12 attached thereto and one or more wheels 16 to aid in easy moving of the device. As seen in FIGS. 1 and 3, lower case 10 also includes a robotic sensor 18, a temperature control pad 14 and a GPS chip 44 for tracking a position of the device. As seen in FIG. 2, the device may be controlled remotely via a remote control 40 and may be tracked via a mobile application on a smartphone 42 (or other similar device).

The temperature inside the inner compartment can be maintained via a cooling system 20 that is powered by one or more batteries 38. In a preferred embodiment, cooling system 20 is a freon-based system. The inner compartment of the device is also configured to hold various organs of different sizes. For example, the device may include a base 28 that is designed to accept different containers, such as a small organ container 32 (for a kidney or heart by way of example, a medium sized container 34 (for a liver, by way of example) and a large container 36 (for lungs, by way of example). Each container (32, 34 and 36) is designed to correspond to an associated divider 30 in base 28 to hold the containers (and associated organs) in a secure manner, as seen by way of example in FIG. 2. In a preferred embodiment, the containers are designed to be disposable after use.

The following describes how to use a device in accordance with the present invention. After harvesting the organ, it will be placed in an appropriately sized sterile container (e.g., 32, 34 or 36), then placed inside the inner compartment of the device and secured via the corresponding divider 30. The appropriate temperature can be set via control pad 14 and maintained via cooling unit 20 and power supply 38. The device can then be transported transport to the appropriate transplant center and its position can be monitored via GPS chip 44 and mobile application 42.

It should be understood, of course, that the foregoing relates to exemplary embodiments of the invention and that modifications may be made without departing from the spirit and scope of the invention as set forth in the following claims.

What is claimed is:

1. A human organ preservation and transportation device comprising:
a lower case;
a lid constructed to engage the lower case and define an inner compartment;
one or more latches to hold the lid to the lower case;
a cooling unit positioned within the inner compartment;
a power source within the inner compartment for powering the cooling unit;
a controller for controlling the cooling unit;
a base unit within the inner compartment to hold an organ container designed to hold a human organ;

2. The human organ preservation and transportation device of claim 1 wherein the base further comprises one or more dividers for holding the organ container in a secure position.

3. The human organ preservation and transportation device of claim 1 further comprising a handle attached to the lower case.

4. The human organ preservation and transportation device of claim 1 further comprising one or more wheels attached to the lower case.

5. The human organ preservation and transportation device of claim 1 further comprising a GPS chip attached to the device.

6. The human organ preservation and transportation device of claim 1 further comprising a remote control to communicate with the controller to control the temperature within the inner compartment.

7. The human organ preservation and transportation device of claim 1 further comprising a mobile application that can communicate with the GPS chip for monitoring the location of the device.

8. The human organ preservation and transportation device of claim 1 wherein the organ container is designed to hold an organ selected from a list of organs comprising a kidney, a heart, a liver or a lung.

9. The human organ preservation and transportation device of claim 1 wherein the organ container is designed to be disposable after use.
